(19) United States
(12) Patent Application Publication
(10) Pub. No.: US 2015/0024346 A1
(43) Pub. Date: Jan. 22, 2015

(54) METHOD OF REMOVING ORAL ROOT TIP

(71) Applicant: Christine Elizabeth Johnson, Seattle, WA (US)

(72) Inventor: Christine Elizabeth Johnson, Seattle, WA (US)

(21) Appl. No.: 13/947,876

(22) Filed: Jul. 22, 2013

(51) Int. Cl. A61C 3/02

(52) U.S. Cl. CPC A61C 3/02
USPC 433/215

(57) ABSTRACT

The present disclosure relates generally to the field of oral surgery and, more particularly, to a minimally invasive method of extracting fractured root tips of teeth from the corresponding tooth socket. In some embodiments, the method comprises the steps of selecting a broken root tip removal instrument which comprises a finger grip coupled to a conical radial tip comprising a spiral cutting screw and then placing the fine point against an exposed surface of a broken root tip, subsequently applying a torque to the finger grip thereby causing the radial tip to screw into the broken root tip such that the root tip removal instrument securely anchors into the broken root tip, and finally applying a force to the finger grip thereby extracting the broken root tip from a root canal.

### CROSS-REFERENCE TO RELATED APPLICATIONS

This application is a division of application Ser. No. 12/156,372 filed May 30, 2008, entitled “Oral surgery instrument, root tip remover and hard tissue excavator, or the like,” (attorney docket number JOHN-1-1001) which claims the benefit of Provisional Application No. 60/936,087 filed Jun. 18, 2007. The foregoing application is incorporated herein by reference in their entirety as if fully set forth herein.

### FIELD OF THE DISCLOSURE

The present disclosure relates generally to the field of oral surgery and, more particularly, to a minimally invasive method of extracting fractured root tips of teeth from the corresponding tooth socket.

### BACKGROUND

There is an ever present need for tools and methods of extracting teeth utilizing minimally invasive procedures. To meet this need, many tools and methods have been designed to remove teeth, root tips of teeth, or the like while inducing minimum trauma to the hard and soft tissues surrounding the subject of extraction. In most cases, the first step of extracting a tooth is to loosen the tooth in the socket by moving the tooth back and forth in the socket utilizing an instrument commonly referred to as a Tooth Elevator. After the tooth has been sufficiently loosened from the periodontal ligament and tooth socket, the dentist will perform the subsequent step of attempting to completely extract the tooth utilizing large forceps which are specifically designed to grip the crown of the tooth while an extracting force is applied. Despite the aforementioned first step of loosening the tooth, all too frequently root tips of teeth facture off from the tooth and remain in bottom of the tooth socket still attached to periodontal ligament. Because Tooth Elevators and Forceps are designed to apply pressure to or grasp the outer surface of the portion of a tooth exposed above the tooth socket, these tools are unable to reach into the tooth socket to separate the remaining root tip from the periodontal ligament for removal.

When a root tip has fractured from the tooth during extraction and remains within the tooth socket, dentists frequently select a high-speed dental handpiece and affix a diamond or carbide burr thereto. Modern dental handpieces can rotate at speeds of up to 400,000 rotations per minute. Even in the hands of a skilled practitioner, such powerful tools cause severe trauma to the hard and soft tissues surrounding the root tip within the tooth socket. The increased trauma greatly increases the healing time of the patient and, in some cases, the patient may not ever fully recover from the procedure. Moreover, in a majority of cases practitioners choose to drill out a portion of the bone in an attempt to create ample space to force a Tooth Elevator into the tooth socket beside the root tip to then pry the root tip out. This method all too often causes great trauma to the hard and soft tissues surrounding the root tip within the tooth socket.

For the foregoing reasons, there is a need for a method of extracting fracture root tips of teeth from the corresponding tooth socket without causing a greater degree of trauma to the hard and soft tissues surrounding the root tip than would have been caused had the root tip been successfully removed with the tooth after having been loosened. Accordingly, such an exercise system is disclosed herein.

### SUMMARY

The present disclosure relates generally to the field of oral surgery and, more particularly, to a minimally invasive method of extracting fractured root tips of teeth from the corresponding tooth socket. This method provides an option for medical practitioners to remove broken root tips from the root socket without causing extensive damage to the surrounding hard and soft tissues.

In some embodiments, the method comprises the steps of selecting a broken root tip removal instrument which comprises a finger grip coupled to a conical radial tip comprising a spiral cutting screw and then placing the fine point against an exposed surface of a broken root tip, subsequently applying a torque to the finger grip thereby causing the radial tip to screw into the broken root tip such that the root tip removal instrument securely anchors into the broken root tip, and finally applying a force to the finger grip thereby extracting the broken root tip from a root canal.

### BRIEF DESCRIPTION OF THE DRAWINGS

These and other features, aspects, and advantages of the present disclosure will become better understood with regard to the following description, appended claims, and accompanying drawings where:

FIG. 1 shows an instrument ideal for selection in performing the minimally invasive method of extracting fractured root tips of teeth from the corresponding tooth socket of the present disclosure.

FIG. 2 illustrates the steps of placing a fine point of the instrument against an exposed surface of a broken root tip and applying a torque thereby anchoring the instrument into the broken root tip.

FIG. 3 shows an instrument anchored into a root tip prior to removal of the broken root tip.

FIG. 4 illustrates the step of applying a force to the finger grip thereby extracting the broken root tip from a root canal.

### DETAILED DESCRIPTION

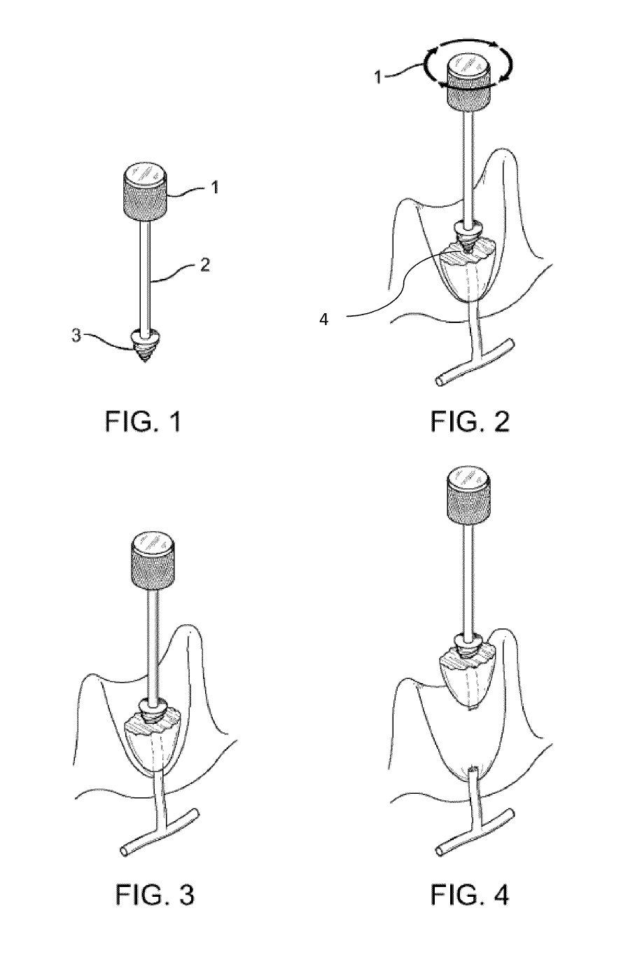

The present disclosure relates generally to the field of oral surgery and, more particularly, to a minimally invasive method of extracting fractured root tips of teeth from the corresponding tooth socket. This method provides an option for medical practitioners to remove broken root tips from the root socket without causing extensive damage to the surrounding hard and soft tissues. Specific details of the method are set forth in the following description and FIGS. 1-4 to provide a thorough understanding of such embodiments. The present invention may have additional embodiments, may be practiced without one or more of the details described for any particular described embodiment, or may have any detail described for one particular embodiment practiced with any other detail described for another embodiment. For example, the method may be performed to remove a tooth that has decayed past the gum line or bone line.

FIG. 1 shows an instrument ideal for selection in performing the minimally invasive method of extracting fractured root tips of teeth from the corresponding tooth socket of the present disclosure. Ideally, the selected instrument comprises an elongate shaft 2 with a first end and a second end wherein the first end is coupled to a finger grip 1 and wherein the second end is coupled to a conical radial tip comprising a spiral cutting screw 3. The finger grip 1 is preferably configured with a rough outer surface, e.g. a knurling pattern, designed to enable a user to perform fine manipulations of the instrument as well as to apply sufficient forces thereto for extracting teeth from a root canal and from a periodontal ligament. The spiral cutting screw 3 is ideally configured for cutting into and anchoring into tooth dentin. The dentin material of teeth is much softer than enamel and, therefore, a sufficiently sharp cutting screw will allow a dentist to screw the tool into a tooth manually. Often times the method disclosed herein will be used to remove broken root tips in which case tooth dentin will normally be exposed.

FIG. 2 illustrates the steps of placing a fine point of the instrument against an exposed surface of a broken root tip and applying a torque thereby anchoring the instrument into the broken root tip. Preferably, an instrument is selected which comprises a sufficiently fine point spiral cutting screw tip such that the tip 4 may be inserted into an exposed root canal of a broken root tip. This is preferable because through the middle of all teeth runs a root canal which contains soft papal tissue. The root canal exits through the apex of the tooth, i.e. the end of the root tip. The existence of an exposed root canal on a broken root tip selected for removal provides for a convenient location for a practitioner to place the cutting screw tip 4 as it will act as a pilot hole for step of applying a torque thereby anchoring in the instrument into the broken root tip as shown in FIG. 3.

As seen in FIG. 2, a steep increase in the diameter of the spiral cutting screw 3 enable the instrument to anchor into the tooth as a torque is applied to the instrument and, more specifically, to the finger grip 1 of the instrument. Preferably, the torque is applied to the finger grip 1 by at least two fingers of the practitioner whom is performing the method.

FIG. 4 illustrates the step of applying a force to the finger grip thereby extracting the broken root tip from a root canal. This step will often require the application of a sufficient force to separate the broken root tip from the periodontal ligament. The step illustrated in FIG. 4 is preferable over alternatives due to the fact that relatively little trauma will generally occur from the step of extracting a broken root tip via the application of a direct force when compared to the level of trauma that typically occurs from the alternative step of loosening the broken root tip by applying leverage to the broken root tip with a Tooth Elevator.

While preferred and alternative embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

what is claimed is:

1. A method for removing a broken root tip of a tooth from a root canal, comprising the steps of:
a. selecting a broken root tip removal instrument which comprises an elongate shaft having a first end and a second end, the first end being coupled to a finger grip and the second end being coupled to a conical radial tip comprising a wide diameter base which reduces to a fine point at the side opposite the elongate shaft wherein the radial tip comprises a spiral cutting screw;
b. placing the fine point against an exposed surface of a broken root tip;
c. applying a torque to the finger grip thereby causing the radial tip to screw into the broken root tip such that the root tip removal instrument securely anchors into the broken root tip; and
d. applying a force to the finger grip thereby extracting the broken root tip from a root canal.

2. The method of claim 1, wherein the exposed surface comprises a root canal disposed within the broken root tip.

3. The method of claim 1, wherein the exposed surface comprises an exposed dentin material and wherein step of applying a torque to the finger grip thereby causes the radial tip to screw into the broken root tip securely anchors the dentin material.

4. The method of claim 1, wherein the step of applying a torque to the finger grip causes the radial tip to screw into a root canal within the broken root tip such that the root tip removal instrument securely anchors into the broken root tip.

5. The method of claim 1, wherein the step of applying a force to the finger grip thereby extracting the broken root tip from a root canal further comprises separating the broken root tip from a periodontal ligament.

6. The method of claim 1, wherein the torque applied in the step of applying a torque to the finger grip is applied by at least two fingers.

7. A method for removing a tooth that has decayed, comprising the steps of:
a. selecting a removal instrument which comprises an elongate shaft having a first end and a second end, the first end being coupled to a finger grip and the second end being coupled to a conical radial tip comprising a wide diameter base which reduces to a fine point at the side opposite the elongate shaft wherein the radial tip comprises a spiral cutting screw;
b. placing the fine point against an exposed surface of a tooth that has decayed;
c. applying a torque to the finger grip thereby causing the radial tip to screw into the tooth that has decayed such that the removal instrument securely anchors into the tooth that has decayed; and
d. applying a force to the finger grip thereby extracting the tooth that has decayed from a root canal.
